(19) United States
(12) Patent Application Publication
(10) Pub. No.: US 2011/0155917 A1
(43) Pub. Date: Jun. 30, 2011

(54) SCINTILLATOR PANEL, RADIATION IMAGING APPARATUS, METHODS OF MANUFACTURING SCINTILLATOR PANEL AND RADIATION IMAGING APPARATUS, AND RADIATION IMAGING SYSTEM

(75) Inventors: Keiichi Nomura, Honjo-shi (JP); Satoshi Okada, Tokyo (JP); Kazumi Nagano, Fujisawa-shi (JP); Yohei Ishida, Honjo-shi (JP)

(73) Assignee: CANON KABUSHIKI KAISHA, Tokyo (JP)

(21) Appl. No.: 12/975,273

(22) Filed: Dec. 21, 2010

(30) Foreign Application Priority Data
Dec. 26, 2009 (JP) 2009-296524

(51) Int. Cl. G01T 1/20; B29C 69/00

(52) U.S. Cl. 250/370.08; 250/370.11; 156/219

(57) ABSTRACT

A scintillator panel includes a substrate and a scintillator layer. The substrate includes a first plate having a surface provided with irregularities, and a flat second plate fixed to the first plate in a confronting relation to the irregularities of the first plate. The scintillator layer is disposed on a surface of the second plate on the side oppositely away from the first plate.

### BACKGROUND OF THE INVENTION

### 1. Field of the Invention

The present invention relates to a scintillator panel, a radiation imaging apparatus using the scintillator panel, methods of manufacturing the scintillator panel and the radiation imaging apparatus, and a radiation imaging system.

2. Description of the Related Art

In one of known scintillator panels, an aluminum substrate, an alumite layer, a metal layer, and a protective film are successively stacked in the order named, and a conversion portion for converting a radiation image into electrical signals is formed on the protective layer (see USP 2008/0308736).

Further, in one of known X-ray image tubes, an input screen includes an input substrate that is prepared, after pressing a substrate into a shape having a substantially spherical (concave) surface, by forming irregularities (projections/recesses), which have an average level difference in the range of 0.3 μm to 4.0 μm, on or in the concave surface with burnishing, and further includes a fluorescent material layer formed on the concave surface of the input substrate (see WO98/012731).

The above-mentioned known scintillator panel has the problem that, when the aluminum substrate is thinned to reduce absorption of radiation by the substrate, the scintillator layer is more apt to peel off due to curving of the aluminum substrate.

The input screen of the above-mentioned known X-ray image tube cannot be applied to a planar radiation imaging apparatus because the input screen is in the shape having the substantially spherical surface.

### SUMMARY OF THE INVENTION

With the view of solving the above-described problems in the related art, aspects of the present invention provide a scintillator panel and a radiation imaging apparatus, which can prevent peeling-off of a scintillator layer formed on a substrate.

According to aspects of the present invention, there is provided a scintillator panel including a substrate and a scintillator layer. The substrate includes a first plate having a surface provided with irregularities, and a flat second plate fixed to the first plate in a confronting relation to the irregularities of the first plate. The scintillator layer is disposed on a surface of the second plate on a side oppositely away from the first plate.

Further, according to aspects of the present invention, there is provided a method of manufacturing a scintillator panel, the method including the steps of forming a first plate having a surface provided with irregularities, fixing a flat second plate to the first plate in a confronting relation to the irregularities of the first plate, and forming a scintillator layer on a surface of the second plate on a side oppositely away from the first plate.

With aspects according to the present invention, the scintillator panel and the radiation imaging apparatus are provided which can suppress peeling-off of the scintillator layer and which have high reliability.

Further features of the present invention will become apparent from the following description of exemplary embodiments with reference to the attached drawings.

### BRIEF DESCRIPTION OF THE DRAWINGS

FIG. 1 is a perspective view of a scintillator panel according to aspects of the present invention.

FIG. 2A is a plan view and FIGS. 2B and 2C are each a front view, partly sectioned, of a scintillator panel according to a first embodiment of the present invention.

FIGS. 3A and 3B are respectively a plan view and a front view, partly sectioned, of a scintillator panel according to a second embodiment of the present invention.

FIGS. 4A and 4B are each a plan view of a scintillator panel according to a third embodiment of the present invention.

FIGS. 5A to 5G are front views, partly sectioned in some of them, illustrating successive manufacturing steps of the scintillator panel according to the first embodiment and a radiation imaging apparatus according to a fourth embodiment of the present invention.

FIG. 6 illustrates the configuration of a radiation imaging system according to a fifth embodiment of the present invention.

### DESCRIPTION OF THE EMBODIMENTS

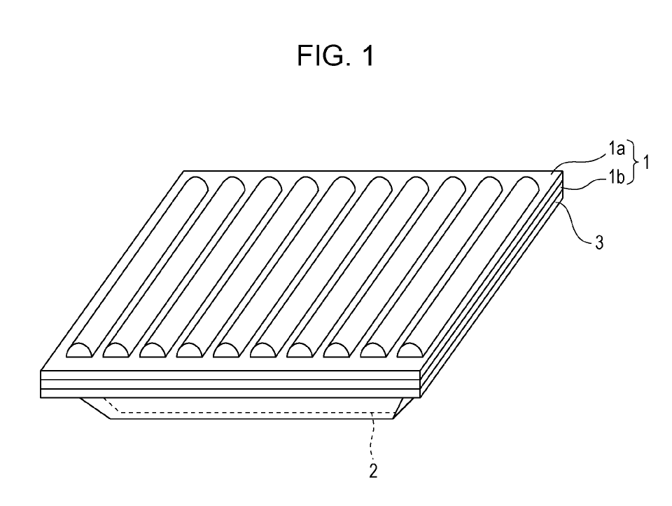

Embodiments of the present invention will be described below with reference to FIGS. 1 to 5.

FIG. 1 is a perspective view of a scintillator panel according to aspects of the present invention.

Reference numeral 1 denotes a substrate including a first plate 1a having an irregular (corrugated) surface, and a second plate lb having a flat surface. A scintillator protective layer 3 is disposed on a scintillator layer 2 that is disposed on a surface of the second plate lb of the substrate 1 on the side oppositely away from the first plate 1a. The scintillator layer 2 is disposed under the substrate 1 to position between the substrate 1 and the scintillator protective layer 3.

The first plate la having the irregular surface includes irregularities (projections/recesses) to increase the strength of the substrate 1. The irregularities can be in the shape of stripes, protrusions, a lattice, a honeycomb, or the like. Further, the irregularities may be in the form projecting from one surface or both surfaces of a flat surface portion. The irregularities can be formed, for example, by embossing to form the irregularities by pressing a die against a flat plate, injection molding, or a method of coating a material over a die having the irregularities by, e.g., spraying or vapor deposition, and then peeling the coated material from the die. The first plate la having the irregular surface is made of a metal, carbon fibers, a ceramic, or a resin. Examples of the metal include Al, Ag, Au, Cu, Ni, Cr, Ti, Pt, Fe and Rh. Further, the metal may be a single metal selected from among the above-mentioned elements, or an alloy (e.g., stainless steel in the case of iron). Typical examples of the resin include an epoxy resin, a silicone resin, polyimide, polyparaxylylene (abbreviated to “parilene” hereinafter), acryl and polyurea.

The second plate lb having the flat surface serves as a member for making flat a surface (region) on which the scintillator layer 2 is to be formed. Thus, the second plate lb has the flat surface in a region corresponding to the region where the scintillator layer 2 is to be formed. The second plate lb also serves as a member for reflecting light emitted from the scintillator layer 2. For that reason, the surface of the second plate 1b on the side adjacent to the scintillator layer 2 may have a high reflectivity. For example, mirror finishing can be used to give a high reflectivity to the surface of the second plate lb on the side adjacent to the scintillator layer 2. A region of the flat second plate 1b, which is positioned to face the first plate 1a, may have a flat surface for easier fixing. A material of the second plate 1b having the flat surface is selected from among Ag, Al, Au, Cu, Ni, Cr, Pt, Ti, Rh, Mo, W, C and Si, as well as alloys, nitrides and oxides of those elements. The second plate 1b can also be formed by plating the surface of a flat plate made of one of the above-mentioned materials with a material having a high reflectivity, such as Al, Ag, Au, Cu, Ni, Cr, Ti, Pt, Rh or the like. Alternatively, a resin, such as an epoxy resin, a hot melt, a silicone resin, a polyimide resin, parilene, acryl, or polyurea, can also be used as the material of the second plate 1b. A composite material formed by stacking a metal plate made of, e.g., aluminum, and a resin into a layered structure is further usable. In the case using the composite material, the second plate 1b can be obtained by bonding an aluminum foil (i.e., a thin plate of aluminum) onto the resin, or by forming a thin film of aluminum on the resin with vapor deposition. When the substrate 1 is formed by using thin metal plates, a total thickness of the substrate 1 may be 100 μm or more and 200 μm or less from the viewpoint of providing satisfactory strength and satisfactory radiation transmittance. When the substrate 1 is formed by using a metallic thin film coated by vapor deposition, for example, a total thickness of a metal portion can be held 0.01 μm or more and 100 μm or less, which may be provided from the viewpoint of increasing the radiation transmittance. Thus, a total thickness of the metal portion of the substrate upon which the radiation is incident may be in the range of 0.01 μm or more to 200 μm or less.

The first plate la having the irregular surface and the second plate lb having the flat surface are fixed to each other to constitute the substrate 1. In order to increase the strength, though not shown, the substrate 1 may further include a third substrate having a flat surface that is disposed on the surface of the first plate 1a on the side oppositely away from the second plate lb so as to provide a structure where the first plate la having the irregular surface is sandwiched between two flat plates. The first and second plates 1a and 1b can be bonded to each other by liquid-phase bonding, such as welding, brazing or soldering, or by solid-phase bonding, such as diffusion bonding, pressure bonding or ultrasonic bonding. A method of fixing two metals or a metal and a resin to each other can be further performed as indirect bonding using an organic or inorganic adhesive that is applied to between the first plate la and the second plate 1b. When the solid-phase bonding is used, ultrasonic welding or surface activation bonding, each of which is one type of pressure bonding, may be provided from the viewpoint of minimizing deformation of the surface of the second plate 1b on the side where the scintillator layer 2 is to be formed. The solid-phase bonding may be performed by using two aluminum plates in consideration of a reflection characteristic and a cost. The adhesive for use in the bonding can be an organic adhesive, such as an epoxy resin, a hot melt, a silicone resin or a polyimide resin, or an inorganic adhesive containing, e.g., alumina, silica or zirconia as a main component. Regardless of what type of method being used, because the substrate 1 is required to be endurable against heat that is applied in a process of forming the scintillator layer 2, the substrate 1 may have heat resistance against temperatures of 180° or higher to 240° C. or lower. In one case, a lower limit of the temperature is 200° C. or higher in terms of heat resistance.

The scintillator layer 2 is disposed on the surface of the second plate 1b of the substrate 1 on the side oppositely away from the first plate 1a. The scintillator layer 2 can be made of a columnar crystal of, e.g., cesium iodide doped with thallium (CsI:Tl), cesium iodide doped with Na (CsI:Na), or sodium iodide doped with thallium (NaI:Tl).

The scintillator protective layer 3 serves as a member for protecting the scintillator layer 2 from external moisture, etc. Also, the scintillator protective layer 3 needs to be transparent so that a sensor panel can detect the light emitted from the scintillator layer 2. The scintillator protective layer 3 is made of an organic resin, such as an epoxy resin, a hot melt, a silicone resin, polyimide, parilene, acryl and polyurea. Alternatively, the scintillator protective layer 3 may have a structure in which a resin and an inorganic material, such as silicon oxide, silicon nitride, or ITO, are stacked one above the other to reduce transmittance against moisture. Be it noted that when the scintillator layer 2 is highly endurable against moisture and is deliquescent at a level not problematic from the practical point of view, the scintillator protective layer 3 may be dispensed with.

The above-described scintillator panel is advantageous in having light weight and high strength by using the substrate 1 that is a combination of the first plate la having sufficient strength and the second plate 1b having the flat surface. Accordingly, peeling-off of the scintillator layer formed on the substrate can be suppressed. Further, since the thickness of the substrate can be reduced, it is possible to reduce radiation absorbance of the substrate when the substrate having the same strength is to be obtained, and to reduce the radiation dose.

The above-described scintillator panel can be combined with a sensor panel to constitute a radiation imaging apparatus, and the radiation imaging apparatus can be further combined with an image processing system, etc. As a result, a satisfactory image can be provided.

### First Embodiment

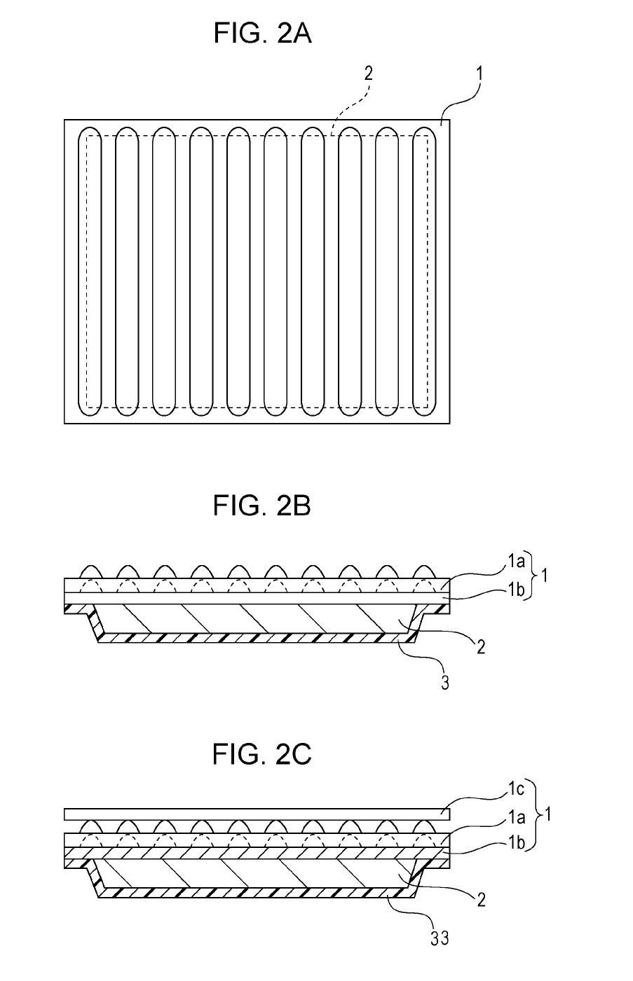

FIG. 2A is a plan view and FIGS. 2B and 2C are each a front view, partly sectioned, of a scintillator panel according to a first embodiment of the present invention.

The scintillator panel includes a substrate 1 and a scintillator layer 2. The substrate 1 has irregularities in the striped shape. More specifically, as illustrated in FIGS. 2A to 2C, a first plate 1a of the substrate 1 has stripe-shaped projections. The stripe-shaped projections are arranged at a pitch of 5 mm and each projection has a width of 3 mm. A second plate lb of the substrate 1 has a flat surface. The first plate 1a and the second plate 1b are each made of aluminum with a thickness of 100 μm and are fixed to each other by using an organic adhesive (not shown) made of a polyimide resin. Because the first plate 1a has a structure that the stripe-shaped projections are projected on one side thereof, the first plate 1a is fixed at the other side having the flat surface to the second plate 1b. Therefore, a contact area between the first plate 1a and the second plate 1b is increased to give the structure with a higher level of strength. The scintillator layer 2 having a thickness of 400 μm is disposed on a surface of the second plate 1b on the side oppositely away from the first plate 1a. The scintillator layer 2 is covered with a scintillator protective layer 3 that has a thickness of 20 μm and that is made of an olefin-based hot melt resin. The scintillator protective layer 3 is disposed over a region wider than the scintillator layer 2 such that the scintillator protective layer 3 contacts with a peripheral surface of the substrate 1 around the scintillator layer 2, i.e., with a peripheral surface of the second plate 1b. Be it noted that the scintillator layer 2 and the scintillator protective layer 3 in each of FIGS. 2B and 2C are illustrated in section, and the scintillator layer 2 is entirely covered with the scintillator protective layer 3 as illustrated in FIG. 1.

With the structure of the substrate 1 illustrated in FIG. 2B, the strength is increased and the substrate 1 is avoided from flexing to a large extent, whereby peeling-off of the scintillator layer 2 can be prevented. Further, with the structure of the substrate 1 in which the first plate 1a is sandwiched between the second plate 1b and a third plate 1c as illustrated in FIG. 2C, the strength of the substrate 1 is further increased and a possibility of peeling-off of the scintillator layer 2 can be further reduced.

According to the first embodiment, as described above, the scintillator panel can be obtained in which the scintillator layer 2 can be prevented from being peeled off. Further, the scintillator panel can be obtained in which since the total thickness of the substrate 1 including the first plate la and the second plate 1b is 200 μm, the substrate thickness can be reduced and absorption of radiation by the substrate can be held at a low level of dose.

### Second Embodiment

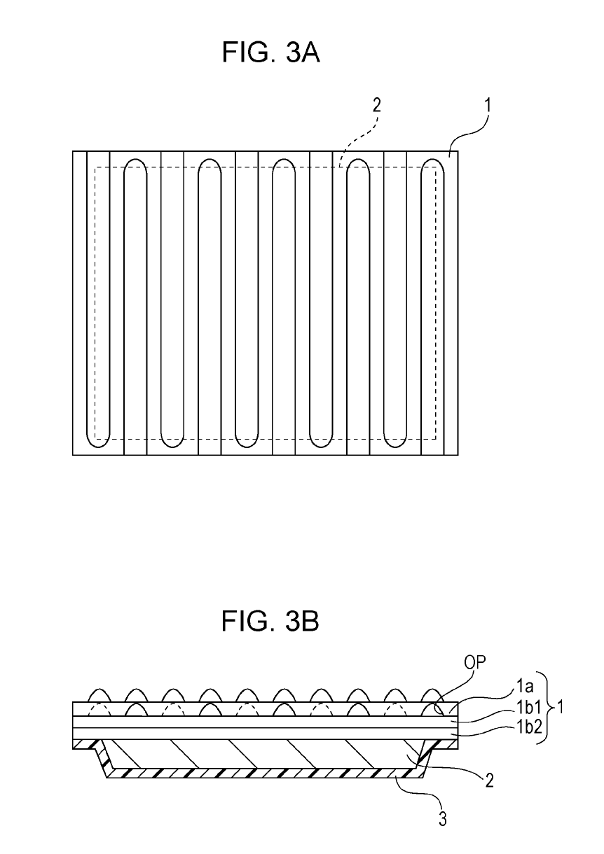

FIGS. 3A and 3B are respectively a plan view and a front view, partly sectioned, of a scintillator panel according to a second embodiment.

The structure of the scintillator panel of the second embodiment differs from that of the first embodiment illustrated in FIGS. 2A to 2C in that the stripe-shaped projections have openings formed at edges of the substrate.

As illustrated in FIGS. 3A and 3B, one end of each of the stripe-shaped projections in the lengthwise direction thereof is extended up to the edge of the substrate 1 to form an opening OP. In FIG. 3B, the scintillator layer 2 and the scintillator protective layer 3 are illustrated in section as in FIGS. 2B and 2C.

With the above-described structure of the second embodiment, an advantage in the manufacturing process can be obtained in that, when the inside of a vacuum deposition apparatus is evacuated in a step of vacuum-depositing the scintillator layer 2, gas present between the projections of the first plate la and the second plate 1b can be smoothly purged out through the openings OP. As a matter of course, the scintillator panel of the second embodiment also has the same advantageous effect as that obtained with the first embodiment.

### Third Embodiment

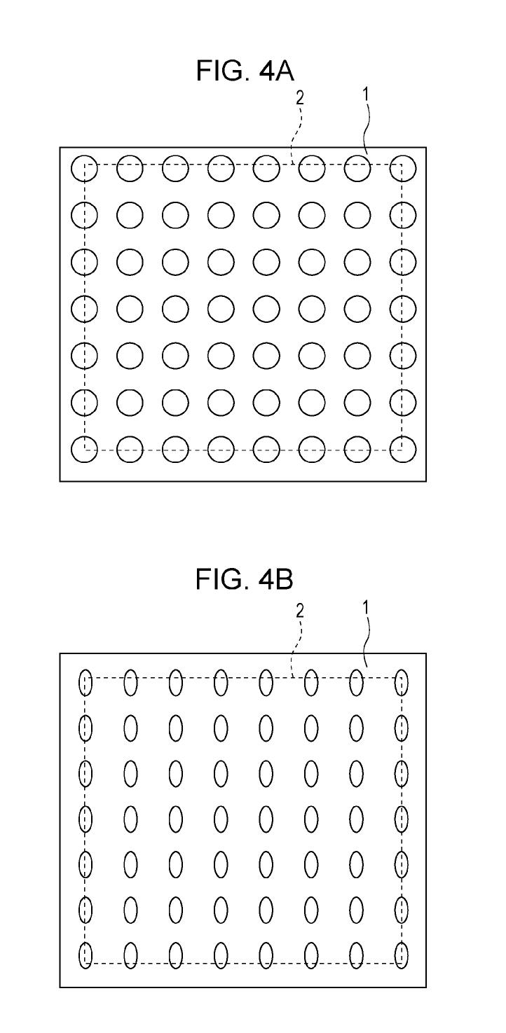

FIGS. 4A and 4B are each a plan view of a scintillator panel according to a third embodiment.

The structure of the scintillator panel of the third embodiment differs from those of the first and second embodiments in that the substrate 1 has projections. Further, each of the first plate 1a and the second plate 1b has a thickness of 50 μm.

FIG. 4A illustrates a structure in which the projections are each projected like a part of a sphere, and FIG. 4B illustrates a structure in which the projections are each projected in an elliptical shape.

With the scintillator panels illustrated in FIGS. 4A and 4B, the strength of the substrate 1 is increased and the substrate 1 is avoided from flexing to a large extent, whereby peeling-off of the scintillator layer 2 can be prevented. In addition, the scintillator panel can be obtained in which since the total thickness of the substrate 1 including the first plate la and the second plate 1b is 100 μm, the substrate thickness can be reduced and absorption of radiation by the substrate can be held at a low level of dose.

### Fourth Embodiment

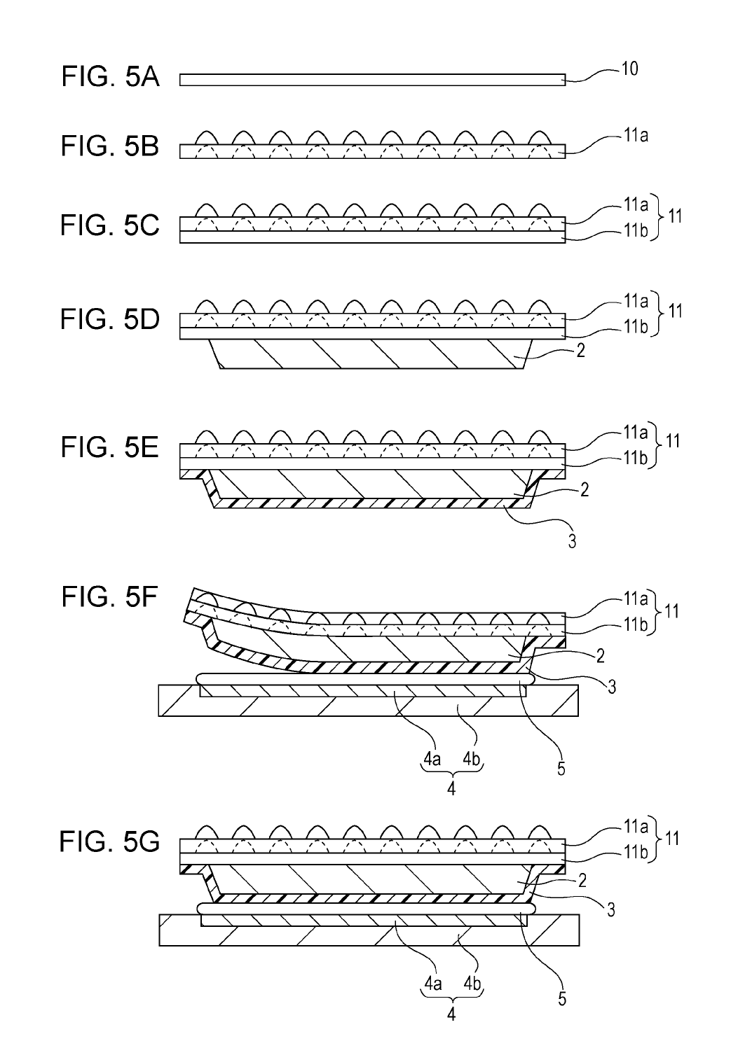

FIGS. 5A to 5G are front views, partly sectioned in some of them, illustrating successive steps of a method of manufacturing the scintillator panel according to the first embodiment, illustrated in FIG. 2B, and a radiation imaging apparatus according to a fourth embodiment of the present invention.

First, a thin plate 10 made of aluminum and having a thickness of 100 pm is prepared (FIG. 5A).

Next, the aluminum plate 10 is embossed to form stripe-shaped projections, thereby forming a first plate 11a (FIG. 5B).

Next, a second plate 11b is entirely coated with a polyimide liquid by a dipping method. After placing the second plate 11b on the first plate 11a, the polyimide liquid is cured in an atmosphere at temperature of 200° C. or higher, thereby forming a substrate 11 (FIG. 5C).

Next, a scintillator layer 2 is formed in a thickness of 400 μm on a surface of the second plate 11b on the side oppositely away from the first plate 11a by vacuum vapor deposition. The scintillator layer 2 is made of CsI:Tl, and the vacuum vapor deposition is carried out by putting CsI and TL in a melting pot (crucible) and by heating the melting pot (FIG. 5D). Deformation of the substrate 11 possibly caused during the vacuum vapor deposition, which is carried out in the vacuum deposition apparatus, can be reduced by fixing at least two sides of the substrate 11, which are extended perpendicularly to the lengthwise direction of the stripe-shaped projections on the substrate 11. Hence, the scintillator layer 2 can be formed in the film thickness as per designed.

Next, a scintillator protective layer 3 made of an olefin-based hot melt resin is formed to cover the scintillator layer 2 (FIG. 5E). The scintillator protective layer 3 and the second plate 11b are positively bonded to each other by press-bonding a peripheral portion of the scintillator protective layer 3 to the second plate 11b under heating. A scintillator panel is completed through the above-described steps.

Next, the scintillator panel is fixed to a sensor panel 4 by using an adhesive 5. At that time, the substrate 11 of the scintillator panel is bonded to the sensor panel 4 gradually from one end to the other end thereof in a direction perpendicular to the lengthwise direction of the stripe-shaped projections (FIG. 5F). The sensor panel 4 includes a substrate 4b and a pixel region 4a in which many pixels including photoelectric conversion elements and switching elements are arrayed. When bonding the scintillator panel to the sensor panel 4, the occurrence of bubbles is reduced by utilizing the fact that the side of the scintillator panel extending in the direction perpendicular to the lengthwise direction of the stripe-shaped projections has a higher flexing characteristic than that extending in the lengthwise direction of the stripe-shaped projections. In other words, by gradually bonding the scintillator panel to the sensor panel 4 from one end to the other end thereof, bubbles are prevented from being generated in a contact region therebetween. Thus, the yield can be increased by utilizing the fact that the flexing characteristic differs depending on the side of the scintillator panel. The scintillator panel in which the flexing characteristic differs depending on the side can be practiced as not only the scintillator panel illustrated in FIGS. 2A and 2B, but also the scintillator panel illustrated in FIG. 4B. Stated another way, such a difference in the flexing characteristic can be obtained by forming the scintillator panel such that the first plate 11a includes a plurality of regions having no projections, which regions are spaced apart from each other in the direction parallel to one side of the first plate 1a. A radiation imaging apparatus, illustrated in FIG. 5G, can be thus obtained. Be it noted that, in FIGS. 5D to 5G, the scintillator layer 2, the scintillator protective layer 3, and the sensor panel 4 are illustrated in section.

While the fourth embodiment has been described, by way of example, in connection with the case where the projections on the first plate 11a are formed by embossing an aluminum plate, the plate material may be a resin, etc. and the projections may be formed by injection molding. While the second plate 11b is formed of a thin aluminum plate, it may be made of a composite material including a resin and a metallic thin film, e.g., an aluminum thin film, formed on the resin by vapor deposition. Using the metallic thin film is advantageous in reducing a thickness as compared with the case using the aluminum thin plate, e.g., an aluminum foil, and hence increasing radiation transmittance. Further, while the first plate 11a and the second plate 11b are bonded to each other by using the adhesive, they may be bonded by using solid-phase bonding, such as pressure bonding or ultrasonic bonding.

### Fifth Embodiment

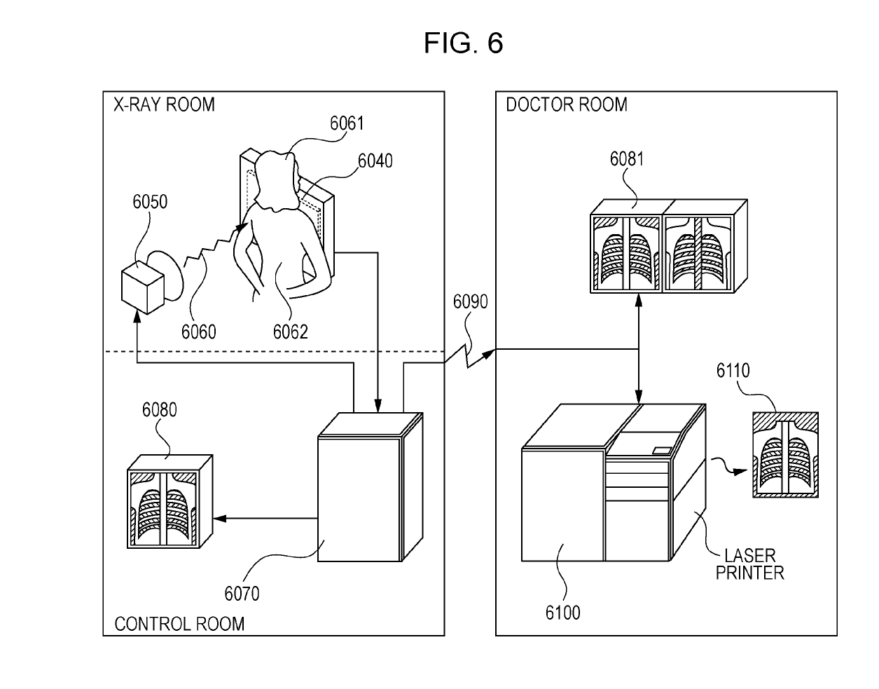

FIG. 6 illustrates an application example of the radiation (X-ray) imaging apparatus according to aspects of the present invention to an X-ray diagnosis system (radiation imaging system). An X-ray 6060 generated by an X-ray tube 6050 (radiation source) passes through the chest 6062 of a patient or an examinee 6061 and enters an image sensor 6040 (radiation imaging apparatus) including a scintillator mounted thereto. The incident X-ray contains information regarding the inside of a body of the patient 6061. The scintillator emits light upon the incidence of the X-ray, and the emitted light is photo-electrically converted so as to obtain electrical information. The electrical information is converted into a digital signal, which is subjected to image processing by an image processor 6070, i.e., a signal processing unit, such that the information can be observed on a display 6080, i.e., a display unit, in a control room. The radiation imaging system includes at least the radiation imaging apparatus and the signal processing unit for processing signals from the radiation imaging apparatus.

The obtained information can be transferred to a remote location through a transmission processing unit, e.g., a telephone line 6090, such that the information can be displayed on a display 6081, i.e., a display unit, which is installed, e.g., in a doctor room at a different place, or can be stored in a recording unit, e.g., an optical disk. Thus, a doctor at the remote location can make diagnosis based on the displayed or stored information. Further, the information can be recorded on a film 6110, i.e., a recording medium, by a film processor 6100 that serves as a recording unit. Alternatively, the information can also be printed on paper by a laser printer that serves as another recording unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-296524 filed Dec. 26, 2009, which is hereby incorporated by reference herein in its entirety.

What is claimed is:

1. A scintillator panel comprising:
a substrate including a first plate having a surface provided with irregularities, and a flat second plate fixed to the first plate in a confronting relation to the irregularities of the first plate; and
a scintillator layer disposed on a surface of the second plate on a side oppositely away from the first plate.

2. The scintillator panel according to claim 1, wherein the first plate of the substrate is made of at least one type of material selected from among metal, ceramic, and resin, and the second plate of the substrate is made of one type of metal selected from among Al, Ag, Au, Cu, Ni, Cr, Ti, Pt, Fe and Rh, or an alloy thereof.

3. The scintillator panel according to claim 2, wherein the first plate of the substrate is made of metal including Al, and a total thickness of respective metal portions of the first plate and the second plate is 0.01 μm or more and 200 μm or less.

4. The scintillator panel according to claim 1, wherein the irregularities have at least one shape selected from among shapes of stripes, protrusions, a lattice, and a honeycomb.

5. The scintillator panel according to claim 1, wherein the scintillator layer is made of a material selected from among CsI:Tl, CsI:Na, and NaI:Tl each having a columnar crystal.

6. A radiation imaging apparatus comprising:
the scintillator panel according to claim 1; and
a sensor panel having a pixel region in which a plurality of pixels each including a photoelectric conversion element are arrayed.

7. A radiation imaging system comprising:
the radiation imaging apparatus according to claim 6; and
a signal processing unit configured to process signals from the radiation imaging apparatus.

8. A method of manufacturing a scintillator panel, the method comprising the steps of:
forming a first plate having a surface provided with irregularities;
fixing a flat second plate to the first plate in a confronting relation to the irregularities of the first plate; and
forming a scintillator layer on a surface of the second plate on a side oppositely away from the first plate.

9. The method of manufacturing the scintillator panel according to claim 8, wherein the irregularities are formed on the first plate by embossing.

10. The method of manufacturing the scintillator panel according to claim 8, wherein the irregularities are formed in the first plate by injection molding.

11. The method of manufacturing the scintillator panel according to claim 8, wherein the first plate is formed by coating a resin or metal material over a die having irregularities.

12. A method of manufacturing a radiation imaging apparatus, the method including the step of:
bonding the scintillator panel formed by the method according to claim 8 to a sensor panel having a pixel region in which a plurality of pixels each including a photoelectric conversion element are arrayed.
